(19) United States
(12) Patent Application Publication
(10) Pub. No.: US 2007/0203847 A1
(43) Pub. Date: Aug. 30, 2007

(54) Electronic payment of content

(75) Inventor: Holger School, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/599,188

(22) PCT Filed: Mar. 15, 2005
(86) PCT No.: PCT/IB05/50902

§ 371 Date: Oct. 31, 2006

(30) Foreign Application Priority Data
Mar. 22, 2004 (EP) 04101178.4

(51) Int. Cl. H04L 9/00

(52) U.S. Cl. 705/64

(57) ABSTRACT

The present invention relates to a method for a receiving device operated by a buyer of performing payment of content to be received from a transmitting device operated by a seller, said method comprises the steps of: setting up a private communication channel between said receiving device and said transmitting device, transmitting a payment container to said transmitting device using said private communication channel, said payment container comprising information authorizing the seller to receive the payment from the buyers bank, receiving said content from said transmitting device based on the arrival of said payment container at said transmitting device. Thereby secure and convenient payment from consumer to consumer or consumer to business is provided, even if no permanent far-range connection to a trust centre or transaction manager is available.

The present invention relates to a method of performing payment of content transferred between a transmitting device and a receiving device. The invention further relates to a computer readable medium having stored therein instructions for causing a processing unit to perform the method. The invention further relates to a receiving device and a transmitting device.

The exchange of digital content is very popular among a large group of Internet users, as the examples of Napster and Kazaa show: At its peak time, Napster counted more than 10 million registered users. But as the example of Napster also illustrates, the content owners push for a rigid implementation of digital rights management (DRM) to protect their content from being distributed illegally. It can be assumed that in the future, digital content, such as music or video, can only be distributed according to a legal license scheme.

If a user moves a song from his player device to another user, he looses the right to consume the song and the new “owner” of the song gains the right to listen to it. On the other hand, if the first user had to pay for the song, he expects a financial compensation for the transfer. This could of course be accomplished by paying ordinary money. But this seems to be somewhat awkward in the context of “invisible” transfer of digital content, and it is definitely inconvenient. As the example of Amazon's “Sell what you bought at Amazon” illustrates, it is very likely that consumers will be more and more willing to re-sell respectively buy pre-owned pay content.

An e-payment method can be better integrated with DRM, especially in more complex scenarios. An interesting content exchange scenario (which might even be more interesting to content providers) is based on content copy:

A user transfers a full copy of a piece of content, e.g. of an MP3 song, to another user:
In the standard version, the recipient simply has to pay a prize for the content to the content owning business. The most convenient way to do this is per e-payment where issues like instant verification of the payment arise.
In a maybe more interesting case, a “sender” of a piece of content will receive an award for each (registered) copy (additionally to any payment the recipient has to make). The sender will e.g. receive a rebate on future payments to the content provider. This stimulates the distribution of pay content and of payments. So, the sender has to prove how many legal copies he has distributed. Then, recipients follow the same scheme. The system functions like the well-known snowball systems. It possibly leads to a viral spread of the pay content. For each copy you receive, you have to pay something to the content providing business, and for each copy you give away, you are rewarded by a rebate e.g. on new content. The most convenient way to handle all the transactions is of course per e-payment.

A lot of attention has been paid to secure e-payment methods. So far, the following approaches exist:
Via a secure Internet connection (e.g. SSL), payment information is exchanged, e.g. credit card information or direct debit authorization is given. The actual payment is then done separately in an “external” step by using the credit card information or by applying the direct debit authorization. The major credit card companies such as MasterCard and Visa try to establish a standard called SET (Secure Electronic Transactions) that facilitates this process. Both methods, SSL and SET, require a trust center in order to establish encryption parameters for a secure communication. Considering the relatively high cost for a single payment, it is more viable for consumer to business payments when the business bears the transaction costs.
With an existing connection to the Internet (via GSM or UMTS), the same methods as for stationary Internet-based e-commerce can in principle be used for m-commerce. But other more appropriate approaches exist, e.g. using SMS-messages or callbacks to a consumer's mobile phone number in order to verify the identity and authorize the payment. For these mobile payments, some standards have been proposed (e.g. mSign), and some methods have gained some market penetration (e.g. paybox, paypal). But none of these solutions or any other method have so far gained a widespread acceptance outside particular user groups. And in general it can be said that the cost-per-use remains high when a far-range network has to be used. This restricts the application of the methods to areas with a high net coverage. Currently, the business partner typically carries the transaction costs in favor of facilitating the e/m-commerce. But involvement of a third party (other than the transaction partners and their banks) as transaction service provider adds to the cost. E.g. paypal takes 2.2% of the transaction plus a fixed 0.30US$ per transaction (status as of December 02), for mobile applications, paybox takes 3.3% of the transaction plus 0.50£ (status as of December02). Hence, the currently proposed standards and methods only fit very well for consumer to business payments, especially for more significant payments, where the business partner is willing to bear the relatively high transaction costs.

It can be said, that no suitable e-payment method for relatively small consumer to consumer payments has been suggested or implemented so far, especially if it is to avoid the costly permanent far-range connection to a trust center or service provider.

It is therefore an object of the present invention to provide a solution to the above mentioned problems.

This is obtained by a method for a receiving device operated by a buyer of performing payment of content to be received from a transmitting device operated by a seller; said method comprises the steps of:
setting up a private communication channel between said receiving device and said transmitting device,
transmitting a payment container to said transmitting device using said private communication channel, said payment container comprising information authorizing the seller to receive the payment from the buyer's bank,
receiving said content from said transmitting device based on the arrival of said payment container at said transmitting device.

Thereby secure and convenient payment from consumer to consumer or consumer to business is provided, even if no permanent far-range connection to a trust centre or transaction manager is available. By avoiding the immanent contact to a trust centre or the financial institute at transaction time in order to achieve real-time verification, the cost-per-use of the payment method can be reduced to a minimum. The method is especially advantageous in consumer to consumer transactions where low cost of the payment method is much more important than the highest possible security and real-time verification or fulfillment. Furthermore, the method can co-exist with any e-payment method that can be processed in real-time.

In a preferred embodiment said payment container comprises authentication data of the buyer, and in specific embodiments the authentication data is e.g. a biometric or a digital signature. Thereby the proposed system is safe against fraud from a third party, i.e. by someone other than the transaction partners. With respect to fraud by the paying transaction partner it can in principle be compared to ordinary check payment with a personal signature. But the identification of a real fraud can be strongly facilitated by incorporating the mentioned digital biometric features (such as a voice print), which could be researched by law enforcement.

In an embodiment the payment container comprises authorisation data to the buyer's bank authorising the bank to perform the payment, said authorisation data being encrypted by the receiving device, whereby only the bank is capable of reading the authorisation data generating a private communication line between the receiving device and the bank via the transmitting device. Thereby the user of the transmitting device does not have access to the personal bank related authorisation data in the payment container.

In an embodiment the steps of the steps of transmitting a payment container to said transmitting device and receiving said content from said transmitting device based on the arrival of said payment container at said transmitting device comprises the steps of:
receiving time restricted content transmitted from said transmitting device using said private communication channel before transmitting said payment container to said transmitting device, said received time restricted content comprising a time restriction whereby said content is accessible on said receiving device in a predefined limited time period,
receiving information from the transmitting device after transmitting said payment container, said information removing said time restriction from said content.

This prevents the buyer from not paying the content after reception, but enables the buyer to verify the content before paying.

The invention further relates to a computer readable medium having stored therein instructions for causing a processing unit in a receiving device to execute the method for a receiving device operated by a buyer of performing payment of content to be received from a transmitting device operated by a seller.

The invention further relates to a method for a transmitting device operated by a seller of receiving payment of content transmitted to a receiving device operated by a buyer; said method comprises the steps of:
setting up a private communication channel between said receiving device and said transmitting device,
receiving a payment container from a receiving device using said private communication channel, said payment container comprising information authorizing the seller to receive the payment from the buyer's bank,
transmitting said content to said receiving device based on the arrival of said payment container.

The invention further relates to a computer readable medium having stored therein instructions for causing a processing unit in a transmitting device to execute the method for a transmitting device operated by a seller of receiving payment of content transmitted to a receiving device operated by a buyer.

The invention also relates to a receiving device adapted to be operated by a buyer for performing payment of content to be received from a transmitting device operated by a seller, said receiving device comprises:
processing and transmitting means for setting up a private communication channel between said receiving device and said transmitting device,
processing and transmitting means for transmitting a payment container to said transmitting device using said private communication channel, said payment container comprising information authorizing the seller to receive the payment from the buyer's bank,
processing and receiving means for receiving said content from said transmitting device based on the arrival of said payment container at said transmitting device.

The invention also relates to a transmitting device operated by a seller for receiving payment of content transmitted to a receiving device operated by a buyer, said transmitting device comprises:
processing and transmitting means for setting up a private communication channel between said receiving device and said transmitting device,
processing and receiving means for receiving a payment container from a receiving device using said private communication channel, said payment container comprising information authorizing the seller to receive the payment from the buyer's bank,
processing and transmitting means for transmitting said content to said receiving device based on the arrival of said payment container.

In the following preferred embodiments of the invention will be described referring to the figures, where

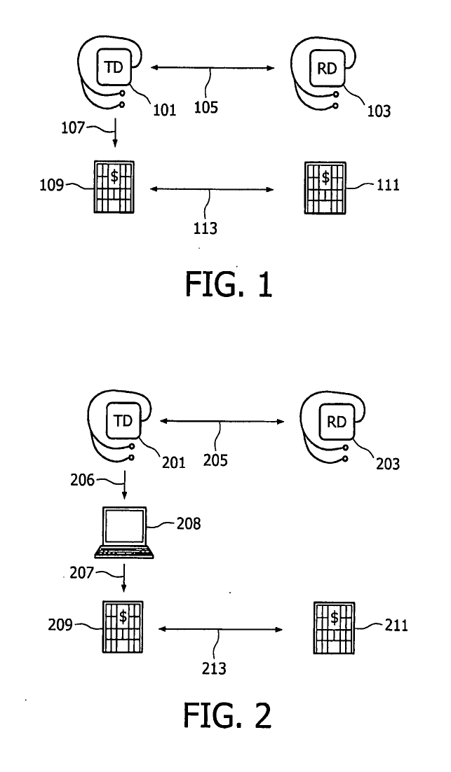

FIG. 1 illustrates a first embodiment of a system for performing payment of content comprising a transmitting device and a receiving device,

FIG. 2 illustrates a second embodiment of a system for performing payment of content comprising a transmitting device and a receiving device,

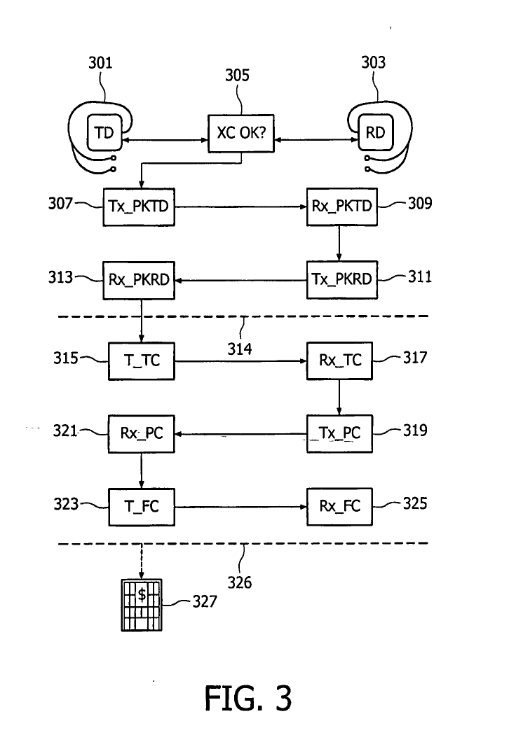

FIG. 3 illustrates the method of transmitting content and paying for content between the transmitting device and the device receiving device,

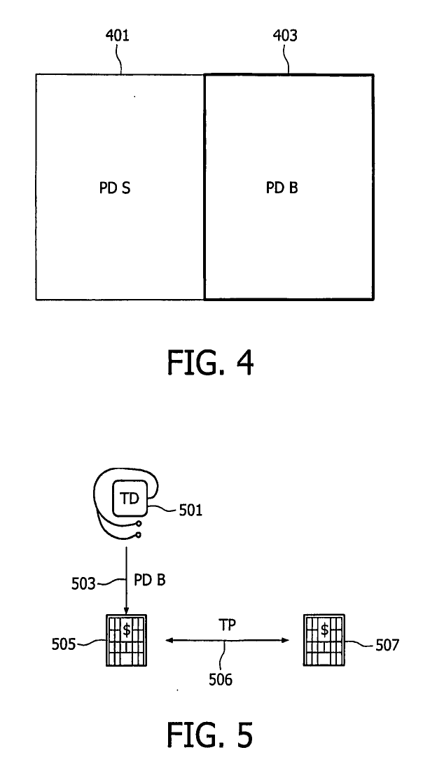

FIG. 4 illustrates the content of a payment container according to the present invention,

FIG. 5 illustrates the sellers receiving the payment from the buyer's bank.

In FIG. 1 a first embodiment of a system for performing payment of content comprising a transmitting device 101 and a receiving device 103 is illustrated. The transmitting device being operated by the seller has content, which the buyer operating the receiving device would like to buy. The content could e.g. be an audio file, such as an MP3 file. Other examples of content can be video content, text files and images. The payment process is then divided in three separate communication steps. In the first step 105 the transmitting device 101 receives a payment container from the receiving device 103. This container could be compared to an electronic bank check and can afterwards be used for receiving the payment from the buyer's bank 111. Further, in 105 the receiving device 103 receives the content from the transmitting device 101. The communication of the content and payment container in 105 can e.g. be performed using wireless short range communication, e.g. based on Bluetooth or Infrared communication. Alternatively, the communication could be performed using a direct wire connection between the receiving device 103 and the transmitting device 101. The transmitting device 101 and receiving device 103 could e.g. be an MP3 player, a mobile phone enabled to play back content or a PDA. Next, the transmitting device communicates 107 with the seller's bank 109 to get the actual payment processed based on the received payment container. The direct communication between the bank 109 and the transmitting device could be performed based on GSM, which of cause requires that the transmitting device has GSM communication abilities. Alternatively, a terminal could be placed in the bank 109, and this terminal could then be used for communicating with the transmitting device 101 enabling the bank to receive the payment container, which the transmitting device 101 has received from the receiving device 103. Finally, after the bank 109 has received the payment container from the transmitting device 101 the bank can process the actual payment of the content by using the payment container and communicating 113 with the buyer's bank 111, e.g. to transfer an amount of money from the buyer's account to the seller's account.

In FIG. 2 a second embodiment of a system for performing payment is illustrated comprising a transmitting device 201 and a receiving device 203. The transmitting device being operated by the seller has content, which the buyer operating the receiving device would like to buy. The payment process is then divided in three separate communication steps. In the first step 205 the transmitting device 201 receives a payment container from the receiving device 203. Further, in 105 the receiving device 103 receives the content from the transmitting device 101. After having received the payment container, the transmitting device could communicate with the bank 209 using an Internet-enabled PC 208 e.g. owned by the buyer. The transmitting device 201 first communicates 206 with the PC 208 to transfer the payment container to the PC 208. This communication could be performed using short range wireless communication e.g. based on Bluetooth or Infrared communication. Alternatively it could be performed using a wire such as USB. Next, the PC 208 communicates 207 with the seller's bank 209 to get the actual payment processed based on the received payment container. The direct communication between the bank 209 and the PC could be performed based on a long range network such as Internet e.g. using net banking. Finally, after the bank 209 has received the payment container from the transmitting device 201, the bank can process the actual payment of the content by using the payment container and communicating 213 with the buyer's bank 211 e.g. to transfer an amount of money from the buyer's account to the seller's account.

In FIG. 3 the method of transmitting content and paying for content between the transmitting device 301 and the receiving device 303 is illustrated. First, in 305 the devices agree on the exchange of content (XC OK?). This is based on software installed on the devices 301, 303 making it possible for the users of the device to select and accept a content transfer. When the exchange has been accepted by both the buyer operating the receiving device 303 and the seller operating the transmitting device 301, the transaction is initiated. Initially a private communication channel is generated. This is performed by exchanging public keys comprising:
transmitting the public key of the transmitting device (Tx_PKTD) in 307 to the receiving device 303,
receiving the public key of the transmitting device (Rx_PKTD) in 309 at the receiving device 303,
transmitting the public key of the receiving device (Tx_PKRD) in 311 to the transmitting device 301,
receiving the public key of the receiving device (Rx_PKRD) in 313 at the transmitting device 301.

In these steps the devices are authenticated. Together with the public keys some details about the transaction partner (such as name, device type) are transmitted in one packet. The transaction partners can then, by their physical neighborhood, authenticate the received keys. This saves the authentication step by a third party trust centre. In cases where full identification is required, the transaction partners can agree on showing legal ID cards. Based on the public key encryption, private encryption parameters are exchanged, and a communication private to the two transaction partners is established. By this measure, no other instance in the network can intelligibly intercept or modify the transmitted data. The dotted line 314 indicates that a private communication line has been established, and the next phase is the actual transfer of data. In 315 the content is transmitted (Tx_TC), but only with a session-validity key (e.g. the content is only usable for a few minutes. This prevents the recipient from not paying the content after reception but enables the verification of the content.). The content is received at the receiving device in 317 (Rx_TC). In 319 the receiving device 319 transmits a payment container to the receiving device (Tx_PC). The payment container comprises information authorizing the seller to receive the payment from the buyer's bank. The payment container is received in 321 by the transmitting device (Rx_PC). After the transfer of the payment container, the full access key is transmitted 323 to the receiving device 303. This full access key is then received by the receiving device in 325 (Rx_FC).

Depending on the particular ‘deal’, the access key may be deleted at the transmitting device. If a content copy was performed, the receiving device might only receive a temporary key. As soon as the payment is acknowledged by the buyer's bank, the buyer will receive a full key (e.g. via email). The dotted line 326 indicates that the transfer of data is finished, and the final process is then for the transmitting device and the seller to receive the actual payment by communicating the received payment container to the seller's bank 327.

In FIG. 4 an embodiment of the content of a payment container according to the present invention is illustrated. The payment container is a packet comprising a first part 401 with authentication message to the seller and a second part 403 with an authentication message to the buyer's bank. The first part 401 could comprise a clear-text part containing some transaction details (such as price, name of transaction partner, payment information) and authentication data being either:
Biometric authentication (such as voiceprint). In order to improve security of the biometric feature it is preferred to record it at transaction time. E.g. in case of a voiceprint, the payer could say his name, date and amount to be paid. This allows the receiving bank to crosscheck whether the biometric authentication data and the transaction request fit together (e.g. by use of automated speech recognition). If the buyer enters his biometric data on the seller's device, the seller can be sure that no hidden manipulation is going on,
Digital signature. The payer could digitally sign the clear-text message.

The second part 403 could comprise an authorisation message to the buyer's bank. The message is encrypted with the public key of the payer's bank and contains an explicit authorisation of the corresponding transaction. As such it can, depending on the specific bank, contain:
Full user identification data,
Details on the current transaction, e.g. name of transaction partner or amount to be paid,
An additional digital signature, biometric authentication data, etc. which replace the secret and that allows the receiving bank to securely verify the authenticity of the transaction request. Preferably, the specific voiceprint mentioned above will be used.

In FIG. 5 the seller receiving the payment from the buyer's bank 507 is illustrated. The transmitting device 501 transmits 503 the payment container to the seller's bank 505. Based on the content in the payment container, the seller's bank 505 establishes a communication line 506 to the buyer's bank 507 to transfer the payment from e.g. the buyer's account to that of the seller.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method for a receiving device operated by a buyer of performing payment of content to be received from a transmitting device operated by a seller, said method comprises the steps of:
setting up a private communication channel between said receiving device and said transmitting device,
transmitting a payment container to said transmitting device using said private communication channel, said payment container comprising information authorizing the seller to receive the payment from the buyer's bank,
receiving said content from said transmitting device based on the arrival of said payment container at said transmitting device.

2. A method according to claim 1, wherein said payment container comprises authentication data of the buyer.

3. A method according to claim 2, wherein the authentication data is biometric.

4. A method according to claim 2, wherein the authentication data is a digital signature.

5. A method according to claim 1, wherein the payment container comprises authorisation data to the buyer's bank authorising the bank to perform the payment, said authorisation data being encrypted by the receiving device, whereby only the bank is capable of reading the authorisation data generating a private communication line between the receiving device and the bank via the transmitting device.

6. A method according to claim 1, wherein the steps of transmitting a payment container to said transmitting device and receiving said content from said transmitting device based on the arrival of said payment container at said transmitting device comprises the steps of:
receiving time restricted content transmitted from said transmitting device using said private communication channel before transmitting said payment container to said transmitting device, said received time restricted content comprising a time restriction whereby said content is accessible on said receiving device in a predefined limited time period,
receiving information from the transmitting device after transmitting said payment container, said information removing said time restriction from said content.

7. A computer readable medium having stored therein instructions for causing a processing unit in a receiving device to execute the method of claim 1.

8. A method for a transmitting device operated by a seller of receiving payment of content transmitted to a receiving device operated by a buyer, said method comprises the steps of:
setting up a private communication channel between said receiving device and said transmitting device,
receiving a payment container from a receiving device using said private communication channel, said payment container comprising information authorizing the seller to receive the payment from the buyer's bank,
transmitting said content to said receiving device based on the arrival of said payment container.

9. A method for a transmitting device operated by a seller of receiving payment of content transmitted to a receiving device operated by a buyer, said method comprises the steps of:
setting up a private communication channel between said receiving device and said transmitting device,
transmitting said content to said receiving device using said private communication channel, said transmitted content comprising a time restriction, whereby said content is accessible on said receiving device in a predefined limited time period,
receiving a payment container from a receiving device using said private communication channel, said payment container comprising information authorizing the seller to receive the payment from the buyer's bank,
transmitting information to the receiving device removing said time restriction from said content.

10. A computer readable medium having stored therein instructions for causing a processing unit in a transmitting device to execute the method of claim 1.

11. A receiving device adapted to be operated by a buyer for performing payment of content to be received from a transmitting device operated by a seller, said receiving device comprises:
processing and transmitting means for setting up a private communication channel between said receiving device and said transmitting device,
processing and transmitting means for transmitting a payment container to said transmitting device using said private communication channel, said payment container comprising information authorizing the seller to receive the payment from the buyer's bank,
processing and receiving means for receiving said content from said transmitting device based on the arrival of said payment container at said transmitting device.

12. A transmitting device operated by a seller for receiving payment of content transmitted to a receiving device operated by a buyer, said transmitting device comprises:
processing and transmitting means for setting up a private communication channel between said receiving device and said transmitting device,
processing and receiving means for receiving a payment container from a receiving device using said private communication channel, said payment container comprising information authorizing the seller to receive the payment from the buyer's bank,
processing and transmitting means for transmitting said content to said receiving device based on the arrival of said payment container.
